(19) United States
(12) Patent Application Publication
(10) Pub. No.: US 2009/0125440 A1
(43) Pub. Date: May 14, 2009

(54) METHOD AND SYSTEM FOR APPROVING CREDIT CARD TRANSACTIONS

(75) Inventor: Aaron K. Maeng, Boston, MA (US)

Correspondence Address: Ruttler Law PLLC;One Union Square, 600 University Street, Suite 1919, Seattle, WA, 98101, US

(73) Assignee: Mr. Joon Maeng, Newcastle, WA (US)

(21) Appl. No.: 12/108,740

(22) Filed: Apr. 24, 2008

Related U.S. Application Data
(60) Provisional application No. 61/002,950, filed on Nov. 13, 2007.

(51) Int. Cl. G06Q 40/00; G06Q 30/00

(52) U.S. Cl. 705/38; 705/26; 705/44

(57) ABSTRACT

This invention relates generally to software, and more specifically, to methods and systems for approving credit card transactions when the purchaser is different from the credit card owner. In one embodiment, the invention includes a method having the steps of receiving an identification of a ware for purchase from a purchaser; receiving contact information for an approver, the approver being different from the purchaser; preparing a purchase order having a payment amount for the ware identified by the purchaser; electronically notifying the approver of the purchase order using the contact information; electronically receiving an approval of the purchase order from the approver, the approval including authorization to charge a credit card of the approver for the payment amount; and processing the credit card for the payment amount.

### PRIORITY CLAIM

This application claims the benefit of U.S. Provisional Application No. 61/002,950 filed Nov. 13, 2007. The foregoing application is incorporated by reference in its entirety as if fully set forth herein.

### FIELD OF THE INVENTION

This invention relates generally to software, and more specifically, to methods and systems for approving credit card transactions when the purchaser is different from the credit card owner.

### BACKGROUND

Historically, purchases for goods and services were made primarily using cash. A purchaser who desired a product or service from a merchant would simply provide the merchant with cash in exchange for the merchant providing the product or service. Alternatively, an individual who desired to pay for a product from a merchant on behalf of a third party purchaser could provide the third party with the cash and the third party could present the cash to the merchant. So long as the third party had cash, the merchant would provide the product to the third party purchaser without concern over who ultimately had paid for the product. Over time, however, more and more financial transactions are being conducted using credit cards rather than cash. Differently from cash transactions, a purchaser who desires a product provides the merchant with a credit card number and an approval to charge the credit card a certain amount in exchange for the merchant providing the product. Generally speaking, the merchant then presents the credit card number and approval to the credit card issuer for payment. The benefits to credit cards are numerous as they are easy to use, especially over the internet, and result in payment guarantee for the merchant.

Despite these benefits one problem persists: purchases using a credit card require approval from the credit card owner. When the purchaser is the credit card owner, there is no problem completing a transaction because the purchaser has the inherent authority to approve the credit card transaction. However, when a purchaser is different from the credit card owner, the credit card owner must be present to approve the transaction for the purchaser or, for online transactions, provide the purchaser with the necessary credit card details so that the purchaser can impersonate the credit card owner. For instance, when a teenager desires to purchase a product from an online merchant using her parent's credit card, her parent either has to make the purchase on behalf of his daughter or provide the teenager with credit card details, such as the credit card number and security code, so that the teenager can impersonate the parent and approve the transaction. The former solution involves significant inconvenience while the latter requires dissemination of valuable information and loss of control over credit card details. While many parents and other credit card owners are reluctant to disseminate their credit card details to teenagers and third party purchasers, they often have little choice considering the inconvenient alternative.

Accordingly, while desirable results have been achieved in the art, there exists much room for improvement. What is needed then are methods and systems for approving credit card transactions when the purchaser is different from the credit card owner.

### SUMMARY

This invention relates generally to software, and more specifically, to methods and systems for approving credit card transactions when the purchaser is different from the credit card owner. In one embodiment, the invention includes a method having the steps of receiving an identification of a ware for purchase from a purchaser; receiving contact information for an approver, the approver being different from the purchaser; preparing a purchase order having a payment amount for the ware identified by the purchaser; electronically notifying the approver of the purchase order using the contact information; electronically receiving an approval of the purchase order from the approver, the approval including authorization to charge a credit card of the approver for the payment amount; and processing the credit card for the payment amount.

### BRIEF DESCRIPTION OF THE DRAWINGS

Embodiments of the present invention are described in detail below with reference to the following drawings:

FIG. 1 is a block diagram of a system for approving credit card transactions when the purchaser is different from the approver, in accordance with an embodiment of the invention;

FIG. 2 is a block diagram of a method for approving credit card transactions when the purchaser is different from the approver wherein the merchant initiates approval from the approver, in accordance with an embodiment of the invention;

FIG. 3 is a block diagram of a method for approving credit card transactions when the purchaser is different from the approver wherein the credit card issuer initiates approval from the approver, in accordance with an embodiment of the invention; and

FIG. 4 is a screenshot of a purchase order presented to an approver through a website for approving credit card transactions when the purchaser is different from the approver, in accordance with an embodiment of the invention.

### DETAILED DESCRIPTION

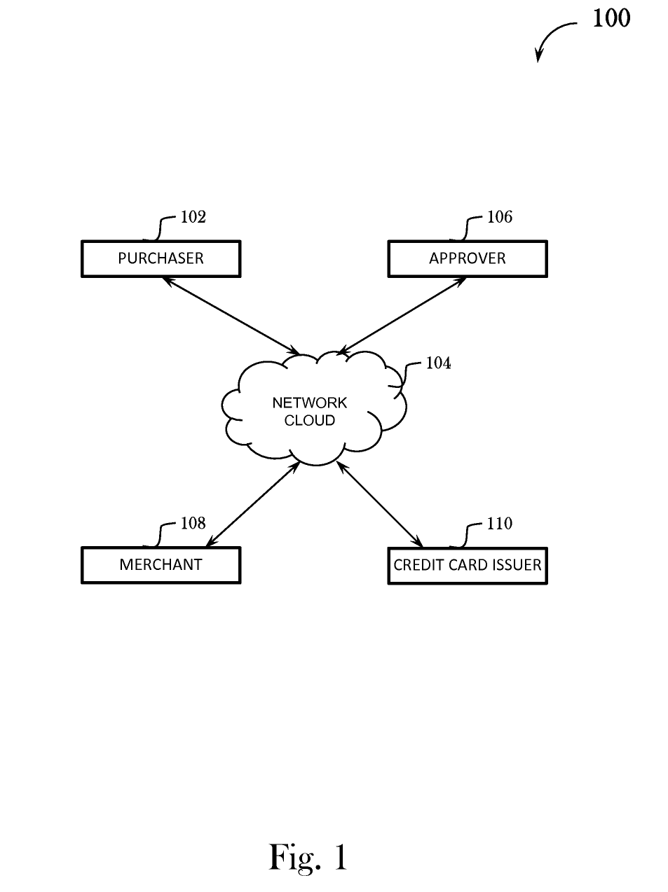

This invention relates generally to software, and more specifically, to methods and systems for approving credit card transactions when the purchaser is different from the credit card owner. Specific details of certain embodiments of the invention are set forth in the following description and in FIGS. 1-4 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a block diagram of a system for approving credit card transactions when the purchaser is different from the approver, in accordance with an embodiment of the invention. In one embodiment, system 100 includes a purchaser 102, an approver 106, a merchant 108, and a credit card issuer 110, any of which each can be communicatably linked via a network 104. The merchant 108 provides goods or services (hereinafter also referred to as “wares”) for purchase either through a physical outlet or online and the approver 106 is the credit card owner. The purchaser 102 is an entity that purchases wares from the merchant 108 that are to be paid for by the approver 106. The credit card issuer 110 is an entity, such as a bank or financial institution, that issues the credit card to the approver 106 and makes payment on behalf of the approver 106 to the merchant 108 for any wares purchased. The network 104 is a communication network such as a public or private wireless or wire-based network including the internet and cellular networks.

In one embodiment, the purchaser 102 identifies a ware for purchase from the merchant 108 and provides contact information for the approver 106. The merchant 108 prepares a purchase order having the identified ware and payment amount, which is sent to the approver 106 electronically using the contact information provided by the purchaser 102. Alternatively, the approver 106 is notified of the purchase order using the contact information and the approver 106 accesses the purchase order for review at a merchant web page. The approver 106 reviews the purchase order having the identified ware and payment amount and determines whether or not to approve the same. Upon approval of the purchase order, the approver 106 provides a credit card to the merchant 108 electronically to satisfy the payment amount and the merchant 108 presents the credit card to the credit card issuer 110 for payment. The merchant 108 provides the ware purchased to the purchaser 102 and the credit card issuer 110 bills the approver 106 for payment.

For example, the purchaser 102 is a college student and the approver 106 is a parent of the college student. The merchant 108 is an online or physical store, such as a campus bookstore that sells educational textbooks. The college student identifies textbooks for purchase from the bookstore and provides contact information for the parent. The bookstore prepares a purchase order for the identified textbooks with a payment amount and notifies the parent of the purchase order using the contact information provided by the college student. The parent reviews the purchase order and provides a credit card electronically to the bookstore for payment of the textbooks. The bookstore presents the credit card to the credit card issuer 110 electronically for payment and provides the textbooks to the college student. Accordingly, the parent is able to conveniently approve payment for the college student's textbooks and the bookstore is able to receive payment without requiring the parent to be physically present at the bookstore or release credit card details to the college student.

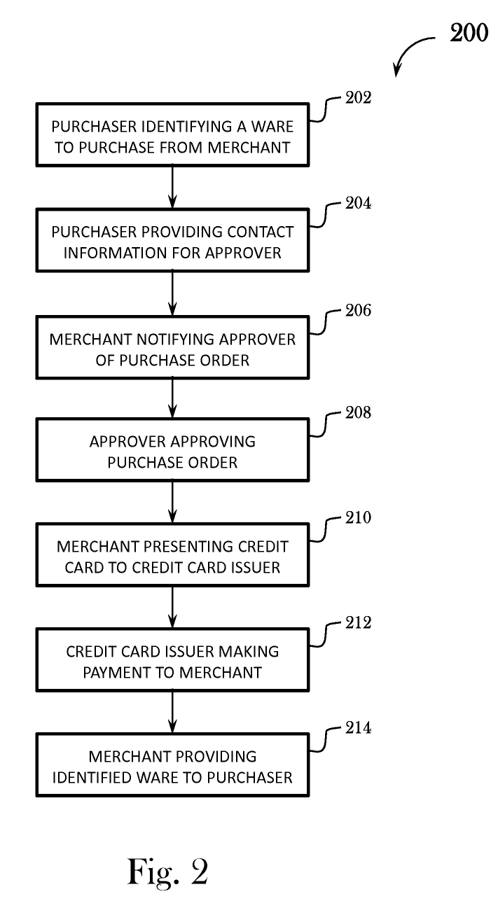

FIG. 2 is a block diagram of a method for approving credit card transactions when the purchaser is different from the approver wherein the merchant initiates approval from the approver, in accordance with an embodiment of the invention. In one embodiment, method 200 includes a purchaser identifying a product or service to purchase from a merchant at block 202, the purchaser providing contact information for an approver at block 204, the merchant notifying the approver of a purchase order at block 206, the approver approving the purchase order 208, the merchant presenting a credit card to a credit card issuer for payment at block 210, the credit card issuer making payment to the merchant at block 212, and the merchant providing the identified product or service to the purchaser at block 214.

In one embodiment, the purchaser identifying a product or service to purchase from a merchant at block 202 includes the purchaser visiting, calling, writing, or otherwise communicating with a physical or online merchant and identifying a product or service for purchase. The purchaser or merchant are an individual, a group, an association, a legal entity, a machine, or a computer, and the merchant sells products or services online, through a physical outlet, or a combination of both. The purchaser visits, calls, writes, or otherwise communicates with the merchant physically or electronically such as in person, through a website, using email, using a phone, through text message, using an instant message, or via another similar methodology. The ware is any tangible or intangible good or service including consumer goods, business goods, financial products, real estate, other tangible and intangible assets, and professional services. In certain embodiments, the identifying a product or service for purchase further includes providing a purchaser name or other purchaser identifier. The purchaser providing contact information for an approver at block 204 includes the purchaser providing a name, home or business address, email address, text message address, instant message address, telephone number, fax number, or other similar information of the approver to the merchant. In one particular embodiment, the purchaser merely provides an account number that is usable by the merchant to retrieve the contact information for the approver. The approver is an individual, a group, association, or legal entity that the purchaser desires to pay for the identified product or service. A purchase order is prepared that includes the purchaser name or other purchaser identifier and the product or service that was identified by the purchaser for purchase. In certain embodiments, the purchase order further includes additional information regarding the purchaser, the merchant, or the product or service identified by the purchaser for purchase. The purchase order is completed by the purchaser, the merchant, a software application, or any combination of the foregoing. The merchant notifying the approver of a purchase order at block 206 includes the merchant presenting the prepared purchase order to the approver electronically through a website, using email, using a phone, through text message, using an instant message, or via another similar methodology, using the contact information provided by the purchaser. In one particular embodiment, the merchant presents the prepared purchase order by requesting electronically that the approver access the purchase order for review, such as through a website or phone system. In certain embodiments, the request includes a Uniform Resource Identifier (URI) of a website or phone number that has the purchase order, an identifier for the purchase order, and a password for accessing the purchase order. In certain additional embodiments, the website provides a secure transaction service between the approver and the website. The secure transaction service is Transport Layer Security (TLS) such as Secure Sockets Layer (SSL) or other similar service.

The approver approving the purchase order at block 208 includes the approver reviewing the purchase order, determining whether to approve the purchase order, and, upon deciding to approve the purchase order, authorizing a credit card for payment of the product or service identified by the purchaser. The reviewing the purchase order includes the approver reviewing the purchaser identity, the identified product or service, the payment amount, and any other additional information on the purchase order. In one particular embodiment, the approver is able to edit, cancel, or otherwise modify the purchase order, such as substituting, augmenting, reducing, or complimenting the identified product or service. The authorizing a credit card for payment includes providing credit card information electronically to the merchant, such as in person, through a website, using email, using a phone, through text message, using an instant message, or via another similar methodology. In one particular embodiment, when the merchant presents the prepared purchase order by requesting that the approver visit a website, the approver accesses the website and, upon deciding to approve the purchase order, the approver provides credit card information through a form on the website. In a further particular embodiment, the approver credit card information is stored from a previous visit by the approver or is provided in whole or in part by the purchaser and the approver approves the purchase order, without providing all or part of any credit card information, by authorizing use of the credit card. In one particular embodiment, a password is usable to authenticate the approver.

Upon approval of the purchase order by the approver, the merchant presents the credit card to a credit card issuer for payment at block 210 and the credit card issuer makes or confirms payment to the merchant at block 212. In certain embodiments, these steps are delayed, omitted, or batched. In other embodiments, the merchant presents the credit card to an intermediary such as a clearinghouse who makes or confirms payment to the merchant. Upon the credit card issuer making or confirming payment the merchant provides the identified product or service to the purchaser at block 214. Alternatively, the merchant provides the identified product or service prior to the credit card issuer making or confirming payment.

In one particular embodiment, the purchaser provides purchaser identifying information, contact information for the approver, approver credit card information, and any other information using a data storage card, such as a magnetic encoded card, a bar coded card, a computer chip embedded card, a RFID card, or some other similar card or data storage device. The merchant uses card or other device reading technology to receive the information from the purchaser and efficiently implement method 200. In another particular embodiment, the approver pre-approves purchases for a purchaser or from a merchant, which may include limits for a specific ware, a payment amount, a frequency or date range, or other similar limit.

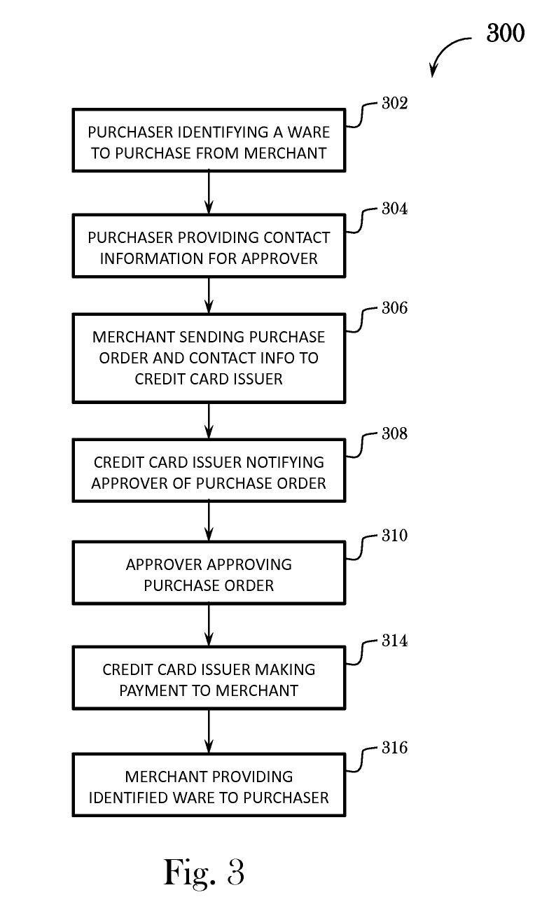

FIG. 3 is a block diagram of a method for approving credit card transactions when the purchaser is different from the approver wherein the credit card issuer initiates approval from the approver, in accordance with an embodiment of the invention. In one embodiment, method 300 includes a purchaser identifying a product or service to purchase from a merchant at block 302, the purchaser providing contact information for an approver at block 304, the merchant sending a purchase order and the contact information to a credit card issuer at block 306, the credit card issuer informing the approver of the purchase order at block 308, the approver approving the purchase order at block 310, the credit card issuer making payment to the merchant at block 312, and the merchant providing the identified product or service to the purchaser at block 314.

In one embodiment, the purchaser identifying a product or service at block 302 and the purchaser providing contact information for an approver at block 304 are analogous to embodiments discussed in reference to method 200. Accordingly, the purchaser visits, calls, writes, or otherwise communicates with a physical or online merchant and identifies a product or service for purchase. In certain embodiments, upon identifying a product or service the purchaser provides a purchaser name or other purchaser identifier and contact information for an approver, such as a name, home or business address, email address, text message address, instant message address, telephone number, fax number, or other similar information of the approver to the merchant. In one particular embodiment, the purchaser further provides an identity of the credit card issuer for the approver's credit card. A purchase order is prepared by the purchaser, the merchant, a software application, or a combination of the foregoing that includes the purchaser identifier, the product or service identified by the purchaser for purchase, and any other additional information regarding the purchaser, the merchant, or the product or service. In certain embodiments, the purchaser provides the purchaser identifier, the contact information for the approver, and any other similar information using a data encoded card or other data storage device.

The merchant sending the purchase order and the contact information to a credit card issuer at block 306 includes the merchant sending the prepared purchase order and the contact information of the approver to the credit card issuer electronically through a website, using email, using a phone, through text message, using an instant message, or via another similar methodology. The credit card issuer informing the approver of the purchase order at block 308 includes the credit card issuer presenting the prepared purchase order to the approver electronically through a website, using email, using a phone, through text message, using an instant message, or via another similar methodology, using the contact information provided by the purchaser and the merchant. In one particular embodiment, the credit card issuer informs the approver of the purchase order by requesting electronically that the approver access the purchase order for review, such as through a website or phone system. In certain embodiments, the request includes a Uniform Resource Identifier (URI) of a website or phone number having the purchase order, an identifier for the purchase order, and a password for accessing the purchase order.

The approver approving the purchase order at block 310 includes the approver reviewing the purchase order, determining whether to approve the purchase order, and, upon deciding to approve the purchase order, authorizing a credit card for payment of the product or service identified by the purchaser. The reviewing the purchase order includes the approver reviewing the purchaser identity, the identified product or service, the payment amount, and any other additional information on the purchase order. In one particular embodiment, the approver is able to edit, cancel, or otherwise modify the purchase order, such as by substituting, augmenting, reducing, or complimenting the identified product or service. The authorizing a credit card for payment includes providing credit card information electronically to the credit card issuer through a website, using email, using a phone, through text message, using an instant message, or via another similar methodology. In one particular embodiment, when the credit card issuer presents the prepared purchase order by requesting that the approver visit a website or phone system, the approver accesses the website or phone system and, upon deciding to approve the purchase order, the approver provides credit card information through a form on the website or a menu of the phone system. In a further particular embodiment, the approver credit card information is stored from a previous visit by the approver, is provided by the purchaser or merchant, or is accessed from the credit card issuer records and the approver approves the purchase order without entering some or any credit card information by authorizing use of the credit card; however, a password may be utilized. Upon the approver approving the purchase order at block 310, the credit card issuer makes payment to the merchant at block 312, and the merchant provides the identified product or service to the purchaser at block 314. Although, in certain embodiments the merchant provides the identified product or service to the purchaser prior to the credit card issuer making payment. Further, any of the steps of method 300 can be delayed, omitted, or batched.

In another embodiment, a clearinghouse or other similar intermediary, interfaces between the merchant and the credit card issuer. The merchant sends the purchase order and the contact information to the clearinghouse and the clearinghouse informs the approver of the purchase order. Upon the approver approving the purchase order, the clearinghouse makes payment to the merchant or notifies the credit card issuer to make payment to the merchant.

In a further embodiment, upon the purchaser identifying a product or service to purchase from a merchant and the purchase order being prepared, the purchaser informs the approver of the purchase order, such as by providing a Uniform Resource Identifier (URI) of a website or phone number having the purchase order, an identifier for the purchase order, and a password for accessing the purchase order. The approver accesses the purchase order, reviews the purchase order, and determines whether to approve the purchase order.

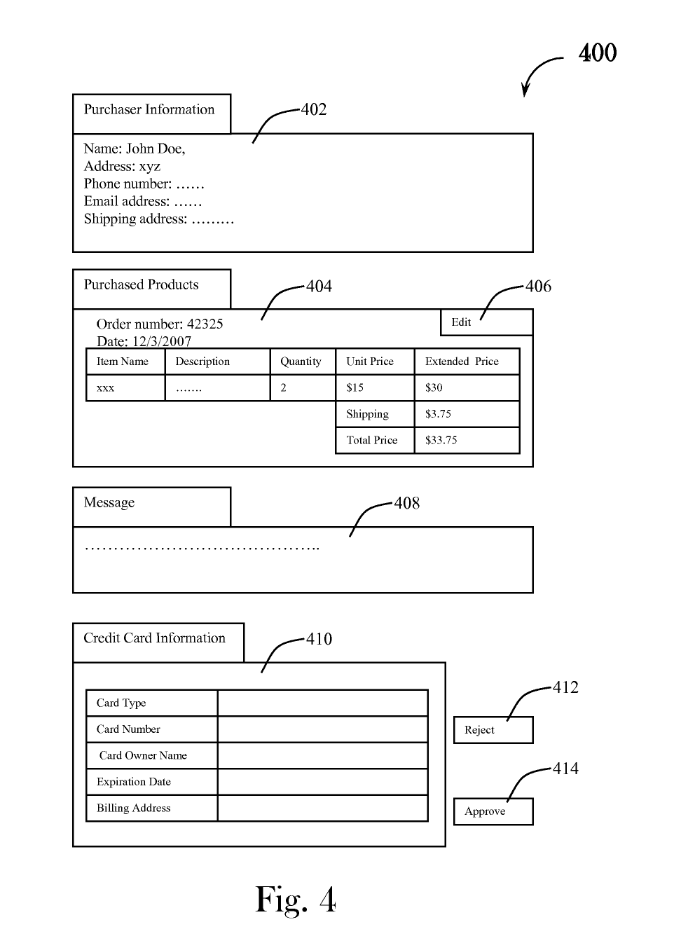

FIG. 4 is a screenshot of a purchase order presented to an approver through a website for approving credit card transactions when the purchaser is different from the approver, in accordance with an embodiment of the invention. In one embodiment, purchase order 400 includes purchaser information 402, product or service identification 404, message 408, and credit card information 410. As discussed in various embodiments herein, the purchase order 400 is prepared by a purchaser, a merchant, a software application, or a combination of the foregoing upon the purchaser identifying a product or service for purchase. The prepared purchase order 400 is presented to the approver electronically by being sent to the approver or by being made accessible to the approver, such as via a website or a phone system. In certain embodiments, when no action is taken by the approver, the purchase order 400 optionally expires or the purchaser or merchant has the option of cancelling the purchase order 400. After approval of the purchase order 400 by the approver, the merchant provides the identified product or service to the purchaser; although, the merchant can provide the identified product or service prior to approval.

The purchaser information 402 includes a purchaser name, address, phone number, email address, shipping address, or other similar information. The purchaser provides the purchaser information 402 upon identifying a product or service to purchase from a merchant. The product or service identification 404 includes details of the product or service identified by the purchaser for purchase from the merchant. Details include a description, quantity, and price of the product or service. In one particular embodiment, the details further include an order number, a date, shipping information, or other similar information. In certain embodiments, the details are modifiable by the approver using an edit operator 406, such as by substituting, augmenting, reducing, or complimenting the identified product or service. The message 408 presents a message for the approver from the purchaser or the merchant or accepts a message from the approver for the purchaser or the merchant. For instance, the message 408 can be a reminder to the approver from the purchaser about the purpose of the identified product or service, can be an entry by the approver as to the reason for rejecting the purchase order, or can be an entry by the approver indicating the reason for modifying the product or service identification 404. The credit card information 410 is a field for receiving credit card information from the approver for payment; alternatively, the credit card information 410 is entirely or partially pre-populated with credit card information from a previous visit by the approver or from the purchaser. A reject operator 412 and an approve operator 414 are usable by the approver to manifest an intent to approve or reject the purchase order 400. In various embodiments, the purchase order 400 has additional elements such as a feature for facilitating communications between the approver and the merchant or the purchaser, such as instant messaging. In other embodiments, the purchase order 400 includes a history of previously approved purchases or a list of recommended products and services for the approver to include with or replace the identified product and service.

In an alternative embodiment, when a purchaser has previously purchased a product or service from a merchant and receives a bill, the purchaser provides contact information for the approver to the merchant in response to the bill. A purchase order is prepared by the purchaser, the merchant, a computer, or a combination of the foregoing and the approver is notified of the purchase order. The approver reviews the purchase order and provides credit card information upon approval of the same. For example, when a student receives a tuition bill for educational classes, the student accesses a website and provides contact information for a parent. A purchase order for the tuition bill is prepared and the parent is notified of the purchase order. The parent reviews the purchase order and upon approval provides credit card information to pay the student tuition bill.

In yet a further embodiment, to prevent credit card fraud, a purchaser and an approver use a previously determined security feature, such as a word, number, code, or phrase. The purchaser provides the security feature to the merchant, which is included in a purchase order for review by the approver. For example, a student and parent can agree on the security phrase “a frog has five legs”. The student provides this security phrase to the merchant, which is included in a purchase order for review by the parent. The presence of “a frog has five legs” on the purchase order indicates to the parent that the student is the purchaser. Differently, the absence of the security phrase or the presence of an incorrect security phrase alerts the parent that the student may not be the purchaser and that fraudulent activity may be present. In additional embodiments, images, sounds, or multiple or interactive security features are usable. For example, a first and second security feature are usable with the first security feature being provided to the approver on notification of the purchase order and the second security feature being provided to the approver on review of the purchase order.

In an additional embodiment, a purchaser or an approver have an account that is accessible by a merchant. The purchaser account stores a purchaser identifier, contact information for the purchaser, or other similar information and is usable by a purchaser to more quickly provide information upon identifying a product or service to purchase. The approver account stores credit card information or approval rules, such as rules to automatically approver purchase orders from a purchaser, from a merchant, or under a pre-determined limit (e.g. less than $50/day or $1500/month), and is usable by the approver to more efficiently review and approve a purchase order. In one particular embodiment, when the approver account automatically approves a purchase order, the merchant notifies the approver of the approval. In further embodiments, the purchaser or approver accounts tracks past purchases and purchase order approvals.

In a further embodiment, the purchase order is for a cash advance or cash withdrawal. For example, a student identifies a cash advance from a bank for purchase and provides contact information for a parent. The student may identify the cash advance physically or electronically such as via a website or an ATM machine. A purchase order is prepared by the student, the bank, a computer, or a combination of the foregoing and the purchase order is made accessible to the parent, such as via a website or phone system. The bank notifies the parent of the purchase order electronically and the parent accesses the purchase order for review. Alternatively, the purchase order is presented to the parent electronically through a website, using email, using a phone, through text message, using an instant message, or via another similar methodology. Upon approval of the purchase order, the bank provides the cash advance to the purchaser.

In yet another embodiment, communication capabilities are provided between a purchaser and an approver upon review of a purchase order by an approver. For example, when the approver accesses a website to review the purchase order, the website indicates whether the purchaser is online. The approver then optionally engages in instant message, chat, video conference, or document sharing communications with the purchaser to discuss the purchase order.

In another embodiment, a card issuer issues a special credit card for a group of related customers that requires approval by an approver as described in various embodiments herein. The group may have one purchaser with multiple approvers, multiple purchasers with one approver, or multiple purchasers with multiple approvers. For example, the group of related customers may be a child (purchaser) with parents (approvers) or children (purchasers) and a father (approver). When there are multiple purchasers, the card issuer may issue credit cards having unique numbers to permit transaction tracking for each credit card.

A computer system or any modern electronic device having a processor that performs equivalent functions is employable to perform the methods and systems described herein. Examples of such devices are personal computers, notebook computers, servers, hand held devices such as wireless telephones, and personal digital assistants. Further, any operating system or application software having the capability of processing electronic commerce in a computer system or modern electronic device is employable to perform the methods and systems described herein. Examples of such operating systems and software include the MICROSOFT Operating System, MICROSOFT INTERNET EXPLORER, FIREFOX browser, SAFARI browser, APPLE Operating System and application software, and web server software and enterprise software by MICROSOFT, ORACLE, SAP and IBM.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for approving credit card transactions when a purchaser is different from an approver, the method comprising the steps of:
receiving an identification of a ware for purchase from a purchaser;
receiving contact information for an approver, the approver being different from the purchaser;
preparing a purchase order having a payment amount for the ware identified by the purchaser;
electronically notifying the approver of the purchase order using the contact information;
electronically receiving an approval of the purchase order from the approver, the approval including authorization to charge a credit card of the approver for the payment amount; and
processing the credit card for the payment amount.

2. The method of claim 1 wherein the receiving an identification of a ware and the receiving contact information is accomplished online.

3. The method of claim 1 wherein the notifying the approver of the purchase order is accomplished by sending the purchase order to the approver via email.

4. The method of claim 1 wherein a merchant initiates notifying the approver of the purchase order.

5. The method of claim 1 wherein the purchase order includes a security feature to authenticate the purchaser.

6. The method of claim 1 wherein the approval of the purchase order is received online.

7. The method of claim 1, further comprising the step of receiving credit card information from the approver.

8. The method of claim 1 wherein the contact information for the approver is received from a purchaser account and wherein the credit card of the approver is received from an approver account.

9. A computer system programmed to perform the method of claim 1.

10. A wireless mobile device programmed to perform the method of claim 1.

11. A computer program embodied in a computer-readable medium and executable by a computer processor for approving credit card transactions when a purchaser is different from an approver, the computer program comprising the steps of:
receiving an identification of a ware for purchase from a purchaser;
receiving contact information for an approver, the approver being different from the purchaser;
preparing a purchase order having a payment amount for the ware identified by the purchaser;
electronically notifying the approver of the purchase order using the contact information;
electronically receiving an approval of the purchase order from the approver, the approval including authorization to charge a credit card of the approver for the payment amount; and
processing the credit card for the payment amount.

12. The computer program of claim 11 wherein the receiving an identification of a ware and the receiving contact information is accomplished online.

13. The computer program of claim 11 wherein the notifying the approver of the purchase order is accomplished by sending the purchase order to the approver via email.

14. The computer program of claim 11 wherein a merchant initiates notifying the approver of the purchase order.

15. The computer program of claim 11 wherein the purchase order includes a security feature to authenticate the purchaser.

16. The computer program of claim 11 wherein the approval of the purchase order is received online.

17. The computer program of claim 11, further comprising the step of receiving credit card information from the approver.

18. The computer program of claim 11 wherein the contact information for the approver is received from a purchaser account and wherein the credit card of the approver is received from an approver account.

19. The computer program of claim 11 further comprising the step of providing electronic communication between the purchaser and the approver.

20. The computer program of claim 11 wherein the ware is a cash advance from a financial institution.
